(19) United States
(12) Patent Application Publication
(10) Pub. No.: US 2007/0230790 A1
(43) Pub. Date: Oct. 4, 2007

(54) CHARACTER RECOGNITION APPARATUS, METHOD AND PROGRAM

(75) Inventor: Yojiro Tonouchi, Kawasaki-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/688,559

(22) Filed: Mar. 20, 2007

(30) Foreign Application Priority Data
Mar. 30, 2006 (JP) 2006-095999

(51) Int. Cl. G06K 9/00

(52) U.S. Cl. 382/187

(57) ABSTRACT

A character recognition apparatus includes an acquisition unit configured to acquire handwriting written in a stroke order, a storage unit configured to store a plurality of character types, a plurality of stroke orders corresponding to each of the character types, and a plurality of frequency information items indicating frequencies with which the stroke orders are used, and a determination unit configured to determine a character type corresponding to the handwriting, based on one of the frequency information items which corresponds to the stroke order.

### CROSS-REFERENCE TO RELATED APPLICATIONS

This application is based upon and claims the benefit of priority from prior Japanese Patent Application No. 2006-095999, filed Mar. 30, 2006, the entire contents of which are incorporated herein by reference.

### BACKGROUND OF THE INVENTION

1. Field of the Invention

The present invention relates to a character recognition apparatus, method and program for recognizing handwriting input to a coordinate input unit such as a touch panel or tablet.

2. Description of the Related Art

When people write a certain character, they do it in various ways. Character recognition apparatuses, which are assumed to be used by the general public, perform recognition processing that can deal with characters written in various ways (see, for example, JP-A 09-269974 (KOKAI) and JP-A 2003-196593 (KOKAI)).

If it is assumed that character recognition apparatuses are used by the general public, it is important that they can recognize various stroke orders. However, if character recognition apparatuses are made to deal with various stroke orders, the possibility of erroneous recognition may well be increased.

For instance, in overwriting character recognition, assume that Japanese symbol [symbol] written in the stroke order of “−”, “−” and [symbol] and Japanese symbol “ [symbol] ” written in the stroke order of [symbol] “−” and “−” are both recognized as the same Japanese symbol [symbol] . In this case, if four strokes of [symbol] “−”, “−” and [symbol] are subjected to recognition, it is ambiguous whether they express a character string [symbol] or another character string [symbol] since the four strokes do not have a clear break.

Assume here that the use of a character recognition apparatus is limited to a certain writer. In this case, substantially one stroke order is used for one character (including a number). It is sufficient if the character recognition apparatus prestores the stroke order of each character by the user and recognizes it. In this case, such a problem as the above does not occur. Most devices, such as PDAs and mobile phones, which may install a character recognition apparatus, are used by a single user, and no particular problems will occur if the use of the apparatus is limited to a particular person.

In the above case, however, it is not easy to acquire the stroke orders of all characters by a particular user. The user must register the stroke orders of all characters at the initial stage of use, which is not easy for them. Further, if the user writes in a different way after registering the stroke orders, the apparatus may not be able to perform any recognition.

### BRIEF SUMMARY OF THE INVENTION

In accordance with a first aspect of the invention, there is provided a character recognition apparatus comprising: an acquisition unit configured to acquire handwriting written in a stroke order; a storage unit configured to store a plurality of character types, a plurality of stroke orders corresponding to each of the character types, and a plurality of frequency information items indicating frequencies with which the stroke orders are used; and a determination unit configured to determine a character type corresponding to the handwriting, based on one of the frequency information items which corresponds to the stroke order.

In accordance with a second aspect of the invention, there is provided a character recognition apparatus comprising: an acquisition unit configured to acquire handwriting written in a stroke order; a storage unit configured to store a plurality of character types, a plurality of stroke orders corresponding to each of the character types, and a plurality of frequency information items indicating frequencies with which the stroke orders are used; a detection unit configured to detect the stroke order and a character type expressed by the acquired handwriting; a selection unit configured to select, from the storage unit, one frequency information item of the frequency information items which corresponds to the detected stroke order and the detected character type; and a determination unit configured to determine a character type corresponding to the acquired handwriting, based on the selected frequency information item and the acquired handwriting.

In accordance with a third aspect of the invention, there is provided a character recognition method comprising: acquiring handwriting written in a stroke order; preparing a storage unit configured to store a plurality of character types, a plurality of stroke orders corresponding to each of the character types, and a plurality of frequency information items indicating frequencies with which the stroke orders are used; and determining a character type corresponding to the handwriting, based on one of the frequency information items which corresponds to the stroke order.

In accordance with a fourth aspect of the invention, there is provided a character recognition method comprising: acquiring handwriting written in a stroke order; preparing a storage unit configured to store a plurality of character types, a plurality of stroke orders corresponding to each of the character types, and a plurality of frequency information items indicating frequencies with which the stroke orders are used; detecting the stroke order and a character type expressed by the acquired handwriting; selecting, from the storage unit, one frequency information item of the frequency information items which corresponds to the detected stroke order and the detected character type; and determining a character type corresponding to the acquired handwriting, based on the selected frequency information item and the acquired handwriting.

In accordance with a fifth aspect of the invention, there is provided a character recognition program stored in a computer readable medium, comprising: means for instructing a computer to acquire handwriting written in a stroke order; means for instructing the computer to access to a storage unit configured to store a plurality of character types, a plurality of stroke orders corresponding to each of the character types, and a plurality of frequency information items indicating frequencies with which the stroke orders are used; and means for instructing the computer to determine a character type corresponding to the handwriting, based on one of the frequency information items which corresponds to the stroke order.

In accordance with a sixth aspect of the invention, there is provided a character recognition program stored in a computer readable medium, comprising: means for instructing a computer to acquire handwriting written in a stroke order; means for instructing the computer to access to a storage unit configured to store a plurality of character types, a plurality of stroke orders corresponding to each of the character types, and a plurality of frequency information items indicating frequencies with which the stroke orders are used; means for instructing the computer to detect the stroke order and a character type expressed by the acquired handwriting; means for instructing the computer to select, from the storage unit, one frequency information item of the frequency information items which corresponds to the detected stroke order and the detected character type; and means for instructing the computer to determine a character type corresponding to the acquired handwriting, based on the selected frequency information item and the acquired handwriting.

### BRIEF DESCRIPTION OF THE SEVERAL VIEWS OF THE DRAWING

FIG. 1 is a block diagram illustrating a character recognition apparatus according to a first embodiment;

FIG. 2 is a table illustrating the content of the stroke-order frequency database (DB) appearing in FIG. 1;

FIG. 3 is a block diagram illustrating a character recognition apparatus according to a second embodiment;

FIG. 4 is a block diagram illustrating the character recognition unit appearing in FIGS. 1 and 3; and

FIG. 5 is a block illustrating a character recognition apparatus acquired by adding a stroke-order determination unit to the apparatus of FIG. 3.

### DETAILED DESCRIPTION OF THE INVENTION

A detailed description will now be given of character recognition apparatuses, methods and programs according to embodiments of the invention will be described with reference to the accompanying drawings.

Firstly, the essential matter of the embodiments will be described briefly.

To perform accurate character recognition in light of a plurality of stroke orders for each character type that may cause erroneous recognition, the character recognition apparatuses according to the embodiments prestore the frequency of each stroke order input to the apparatuses. After that, the apparatuses check the stroke order of the highest input frequency for each character type, and regard it as the stroke order unique to a user (learning of the stroke order of each character type). Based on the stroke order of the highest input frequency related to each character type, the apparatuses recognize each character.

The main procedure of the character recognition apparatuses of the embodiments is as follows:

1. A stroke-order frequency database (DB) is prepared for storing the frequency of an input stroke order corresponding to each character type.

2. Character recognition processing is performed to determine the type of the character input and the stroke order of the character type. At this time, the stroke-order frequency DB outputs a stroke order of a higher input frequency in preference to a stroke order of a lower input frequency.

3. Based on the determination result of the above item 2, the stroke-order frequency DB is updated.

The character recognition apparatuses, methods and programs of the embodiments can perform character recognition accurate and convenient to users.

### First Embodiment

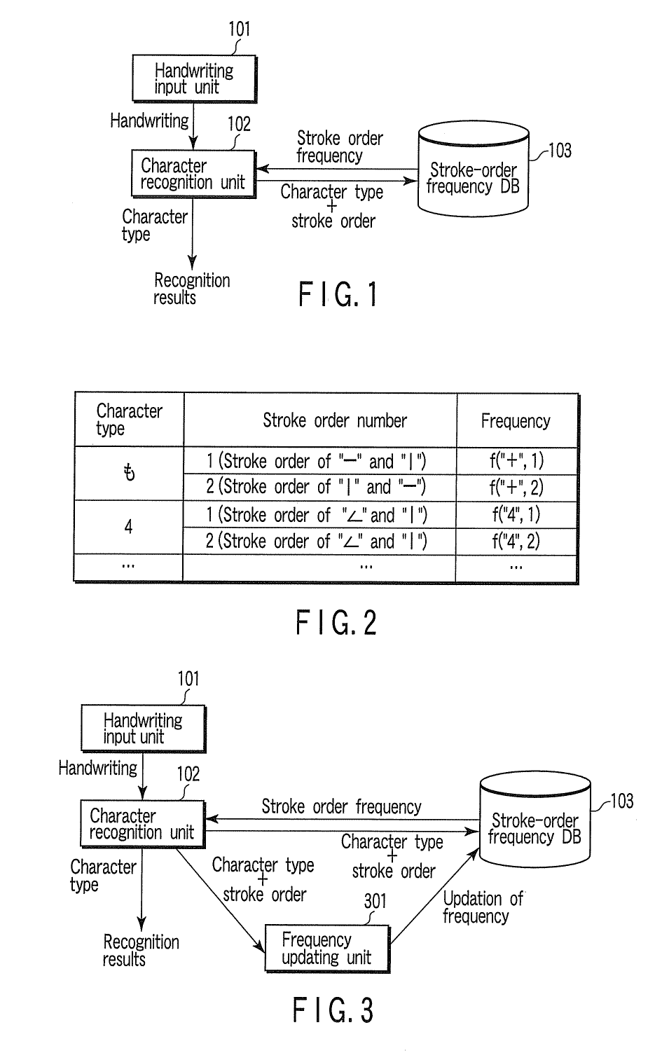

Referring to FIG. 1, a character recognition apparatus according to a first embodiment will be described.

The character recognition apparatus comprises a handwriting input unit 101, character recognition unit 102 and stroke-order frequency DB 103.

The handwriting input unit 101 acquires the handwriting of a user. Namely, it acquires the traces of handwriting in order. The handwriting input unit 101 supplies the character recognition unit 102 with, for example, the coordinates and time of each of the points included in the handwriting. Alternatively, the handwriting input unit 101 may supply the character recognition unit 102 with the coordinates of handwriting whenever it detects the handwriting. In this case, the character recognition unit 102 records the time when it receives the coordinates from the handwriting input unit 101. The character recognition unit 102 can reproduce the handwriting from the coordinates and time. The handwriting input unit 101 incorporates a tablet (not shown). When a user writes a character on the handwriting input region of the tablet, using, for example, a dedicated pen, the tablet detects handwriting data (time-sequence data of coordinate values) corresponding to the character. The coordinate data sequence ranging from the time when the pen touches the tablet to the time when it is detached therefrom, i.e., the coordinate data sequence of handwriting, is treated as data in block, called a stroke. Thus, the coordinate data sequence is acquired as stroke data.

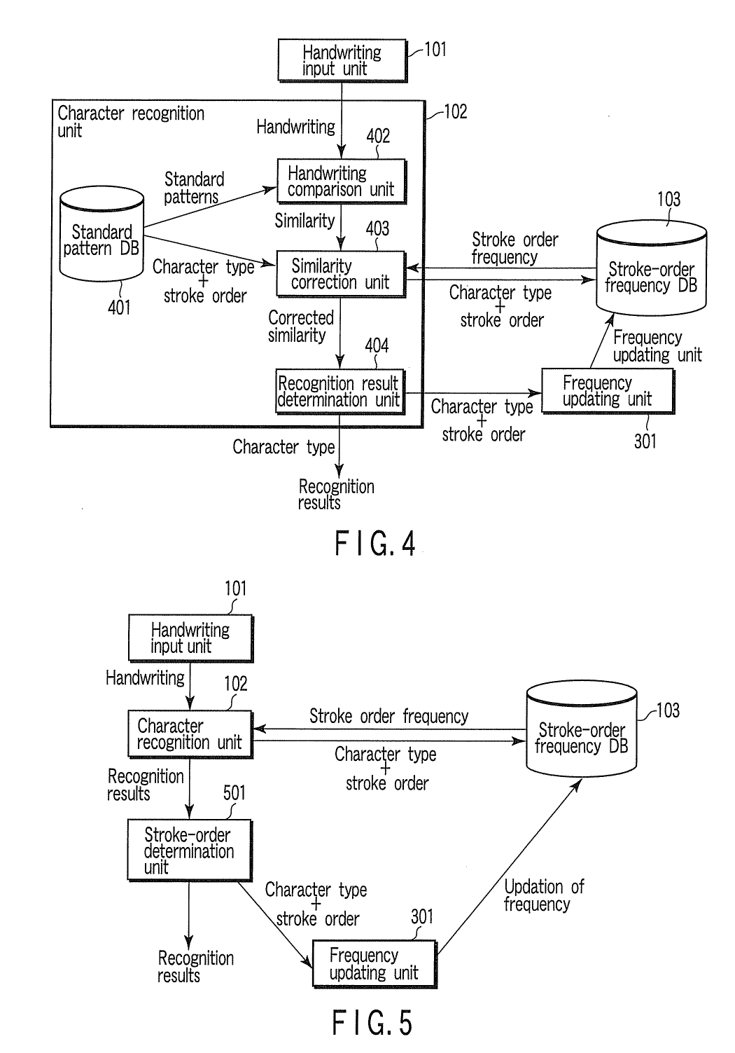

The character recognition unit 102 performs character recognition processing on the handwriting (stroke) output from the handwriting input unit 101, and outputs the recognition result. During character recognition processing, the character recognition unit 102 acquires stroke-order frequency data from the stroke-order frequency DB 103, and performs character recognition referring to the stroke-order frequency data. The character recognition unit 102 detects a character type and stroke order in the handwriting data output from the handwriting input unit 101, and acquires, from the stroke-order frequency DB 103, a stroke-order frequency corresponding to the detected character type and stroke order. Based on the acquired stroke-order frequency and handwriting, the character recognition unit 102 determines the character type corresponding to the handwriting. Referring to FIG. 4, the process performed by the character recognition unit 102 will be described in detail later.

The stroke-order frequency DB 103 stores a plurality of character types, a plurality of stroke orders corresponding to each of the character types, and the input frequency of each of the stroke orders. The stroke-order frequency DB 103 acquires, from the character recognition unit 102, a character type and stroke order, and supplies the character recognition unit 102 with the stroke-order frequency data corresponding to the character type and stroke order. Character types are, for example, [symbol] [symbol] (Japanese symbols), [symbol] [symbol] (another type of Japanese symbols used to spell out words that are foreign to Japanese), “C”, “D”, “4” and “5”. “Stroke order” is designated by “stroke-order number”. “Stroke-order frequency” indicates the frequency of a certain stroke order with which a certain character type is written. More specifically, “frequency” indicates the number of accumulations of a certain stroke order with which a certain character type is written.

Referring to FIG. 2, the data stored in the stroke-order frequency DB 103 will be described.

In the example of FIG. 2, character types, [symbol] and “4”, are employed as different character types, and a plurality of stroke orders, with which these character types are written, are denoted by stroke-order numbers “1” and “2”. For instance, stroke-order number “1” corresponding to a character type, “+”, indicates that this character type is written by firstly writing two horizontal strokes, “−”, and then writing the other stroke, “|”. “Frequency” is expressed in the form of, for example, ‘f (“+”, 1)’. ‘f (“+”, 2)’ indicates the frequency with which the character type “+” is written using the stroke order indicated by stroke-order number “1”.

In the above-described character recognition apparatus, erroneous recognition, which may occur when a plurality of stroke orders are used for one character type, can be reduced by utilizing the stroke-order frequency. In particular, the character recognition apparatus of the first embodiment is advantageous to overcome the problem that “when a certain character is written with a plurality of stroke orders, if the character is written alone, it can be correctly recognized, whereas if the character is combined with another particular character, it may be incorrectly recognized.” Thus, the character recognition apparatus of the first embodiment realizes character recognition accurate and convenient to users.

### Second Embodiment

Referring to FIG. 3, a character recognition apparatus according to a second embodiment will be described.

The character recognition apparatus according to the second embodiment a frequency updating unit 301, in addition to the elements employed in the apparatus of the first embodiment. In the first embodiment, the content of the stroke-order frequency DB 103 is unchanged, while in the second embodiment, the content of the stroke-order frequency DB 103 is updated whenever character recognition is carried out. In the description below, the elements similar to those described above are denoted by corresponding reference numbers, and no detailed description is given thereof.

The frequency updating unit 301 updates the frequencies stored in the stroke-order frequency DB 103. More specifically, to update the stroke-order frequency, the frequency updating unit 301, for example, increments the frequency whenever it recognizes a stroke order with which a user writes. Alternatively, the frequency updating unit 301 sets, to 1, the frequency of the stroke order with which a user currently writes a certain character type, and the frequency of any stroke order other than the current stroke order is set to 0. In the first-mentioned case, the frequency of a stroke order used so far is recorded, while in the second-mentioned case, only the last input stroke order is recorded.

Referring to FIG. 4, the character recognition unit 102 will be described.

As shown, the character recognition unit 102 comprises a standard pattern DB 401, handwriting comparison unit 402, similarity correction unit 403 and recognition result determination unit 404.

The standard pattern DB 401 stores standard patterns corresponding to the stroke orders of various types of characters. More specifically, each standard pattern is a combination of trace information indicating the traces of handwriting of the corresponding character type, and order information indicating the order of the traces. The trace information can be indicated by two independent coordinates. If a character type is divided into parts, the order of the traces of handwriting is the order in which the parts are written. In the case of, for example, “+”, the order information indicates that firstly, the horizontal stroke, “−”, of “+” is written, and secondly, the vertical stroke, “|”, of “+” is written. In the case of “+”, there is other order information. In this case, for example, the vertical stroke other than the horizontal stroke, i.e., “|”, is firstly written, and lastly, the horizontal stroke, “−”, of “+” is written. Thus, the standard pattern DB 401 generally stores a plurality of standard patterns for each character type. As mentioned above, a plurality of standard patterns are imparted to a character type, if the character type can be written in different stroke orders.

The handwriting comparison unit 402 compares the input handwriting with each of the corresponding standards patterns to compute the similarity therebetween. Specifically, the handwriting comparison unit 402 compares the input handwriting with each of the corresponding standards patterns stored in the standard pattern DB 401. Based on the comparison results, the handwriting comparison unit 402 determines the degree of similarity between the handwriting and a combination of the corresponding character type and stroke order.

Based on the degree of similarity acquired from the handwriting comparison unit 402, and the stroke-order frequency acquired from the stroke-order frequency DB 103, the similarity correction unit 403 computes a corrected degree of similarity that is the final degree of similarity between the handwriting and the standard patterns.

Specifically, the successive strokes of the pattern (handwriting pattern formed of stroke information) of the handwriting (handwritten character) input through the handwriting input unit 101 are combined with their orders unchanged. Similarly, the successive strokes of each standard pattern stored in the standard pattern DB 401 are combined with their orders unchanged. The thus-acquired successive strokes are made to correspond between the handwriting pattern and each standard pattern, thereby realizing strokes-versus-strokes correspondence. The distance between each pair of corresponding strokes thus acquired is computed, and the sum of the computed distances is acquired as the distance between the handwriting pattern and each standard pattern. Subsequently, the minimum one of the acquired sums is determined. The character expressed by the standard pattern corresponding to the minimum sum is determined as the recognition result. Namely, it is determined which one of the pairs of strokes has the highest similarity. In this case, the pair of strokes, which provides the minimum sum, is considered to have the highest similarity. However, other character recognition methods and other similarity computation methods may be employed.

The similarity correction unit 403 performs such computation as below. Assume here that the degree of similarity acquired from the handwriting comparison unit 402 concerning character C with stroke-order number i is d1(C, i), the frequency acquired from the stroke-order frequency DB 103 is f(C, i), and the corrected degree of similarity computed by the similarity correction unit 403 is d2(C, i). In this case, d2(C, i) is given by
d2(C, i)=d1(C, i)+kf(C, i) (k is a proportion multiplier)

If there is a character that has no corresponding stroke-order frequency in the stroke-order frequency DB 103, it is sufficient if f(C, i)=0.
Namely, d2(C, i)=d1(C, i)

The recognition result determination unit 404 causes the similarity correction unit 403 to compute corrected degrees of similarity concerning all standard patterns stored in the standard pattern DB 401, thereby selecting the character type (and stroke order) of the highest corrected degree of similarity, and outputting, as the final recognition result, this character type (and stroke order).

Referring to FIGS. 3 and 5, a description will be given of the time of updating the stroke-order frequency by the frequency updating unit 301.

When the stroke-order frequency DB 103 is updated based on the recognition results of the character recognition unit 102, it is updated based on the character type and stroke order output from the character recognition unit 102, whenever character recognition processing is performed, as is shown in FIG. 3.

However, the stroke order output from the character recognition unit 102 is not always identical to the stroke order actually input by a user. To avoid such inconsistency, the character recognition apparatus may incorporate a stroke-order determination unit 501 as shown in FIG. 5.

The stroke-order determination unit 501 receives the recognition results output from the character recognition unit 102, and provides them for the user. In accordance with an explicit or implicit instruction from the user, the stroke-order determination unit 501 determines the character type and stroke order of the frequency to be updated. Further, the stroke-order determination unit 501 outputs the determined character type and stroke order to the frequency updating unit 301.

If the user accepts the recognition results from the character recognition unit 102, the stroke-order determination unit 501 determines that the recognition results are correct, determines the stroke order and outputs the character type and determined stroke order to the frequency updating unit 301.

In contrast, if the user rejects the recognition results from the character recognition unit 102, the stroke-order determination unit 501 determines that the recognition results are incorrect, and outputs neither the character type nor the stroke order. If the recognition results are formed of a plurality of candidates, the stroke-order determination unit 501 determines the stroke order corresponding to those of the recognition results selected by the user, and outputs the determined stroke order and character type to the frequency updating unit 301.

In the character recognition apparatus according to the second embodiment, even if the writer (user) changes, this can be dealt with, since the stroke-order frequency DB is automatically updated. The stroke-order frequency DB enables the stroke order of each user to be automatically learned. Further, even after learning a certain stroke order, the stroke-order frequency DB enables a plurality of stroke orders to be dealt with. Thus, the character recognition apparatus of the second embodiment can perform character recognition accurate and convenient to users.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A character recognition apparatus comprising:
an acquisition unit configured to acquire handwriting written in a stroke order;
a storage unit configured to store a plurality of character types, a plurality of stroke orders corresponding to each of the character types, and a plurality of frequency information items indicating frequencies with which the stroke orders are used; and
a determination unit configured to determine a character type corresponding to the handwriting, based on one of the frequency information items which corresponds to the stroke order.

2. A character recognition apparatus comprising:
an acquisition unit configured to acquire handwriting written in a stroke order;
a storage unit configured to store a plurality of character types, a plurality of stroke orders corresponding to each of the character types, and a plurality of frequency information items indicating frequencies with which the stroke orders are used;
a detection unit configured to detect the stroke order and a character type expressed by the acquired handwriting;
a selection unit configured to select, from the storage unit, one frequency information item of the frequency information items which corresponds to the detected stroke order and the detected character type; and
a determination unit configured to determine a character type corresponding to the acquired handwriting, based on the selected frequency information item and the acquired handwriting.

3. The apparatus according to claim 2, further comprising:
a determination unit configured to determine a stroke order corresponding to the acquired handwriting, based on the selected frequency information item and the acquired handwriting; and
an updating unit configured to update the frequency information items based on the determined character type and the determined stroke order.

4. The apparatus according to claim 2, further comprising:
a determination unit configured to determine a stroke order corresponding to the acquired handwriting, based on the selected frequency information item and the acquired handwriting;
a provision unit configured to provide the determined character type and the determined stroke order;
an acceptance unit configured to accept determination results indicating whether the provided character type and the provided stroke order are correct; and
an updating unit configured to update the frequency information items, if the determination results indicate that the provided character type and the provided stroke order are correct.

5. The apparatus according to claim 2, wherein the detection unit includes:
a storage unit configured to store, as standard patterns, trace information items which corresponds to the character types and the stroke orders; and
a comparison unit configured to compare the acquired handwriting with each of the standard patterns, to compute a degree of similarity between a combination of the stroke order and the character type expressed by the acquired handwriting, and a combination of a corresponding character type and a corresponding stroke order included in each standard pattern.

6. The apparatus according to claim 5, wherein the determination unit includes:
a correction unit configured to correct the degree of similarity based on the selected frequency information item, and to acquire a corrected degree of similarity;
a computation unit configured to compute the corrected degree of similarity in units of combinations of character types and corresponding stroke orders included in the standard patterns; and
a selection unit configured to select, from the computed corrected degree of similarity in units of the combinations, a character type included in a combination which is a highest corrected degree of similarity.

7. A character recognition method comprising:
acquiring handwriting written in a stroke order;
preparing a storage unit configured to store a plurality of character types, a plurality of stroke orders corresponding to each of the character types, and a plurality of frequency information items indicating frequencies with which the stroke orders are used; and
determining a character type corresponding to the handwriting, based on one of the frequency information items which corresponds to the stroke order.

8. A character recognition method comprising:
acquiring handwriting written in a stroke order;
preparing a storage unit configured to store a plurality of character types, a plurality of stroke orders corresponding to each of the character types, and a plurality of frequency information items indicating frequencies with which the stroke orders are used;
detecting the stroke order and a character type expressed by the acquired handwriting;
selecting, from the storage unit, one frequency information item of the frequency information items which corresponds to the detected stroke order and the detected character type; and
determining a character type corresponding to the acquired handwriting, based on the selected frequency information item and the acquired handwriting.

9. The method according to claim 8, further comprising:
determining a stroke order corresponding to the acquired handwriting, based on the selected frequency information item and the acquired handwriting; and
updating the frequency information items based on the determined character type and the determined stroke order.

10. The method according to claim 8, further comprising:
determining a stroke order corresponding to the acquired handwriting, based on the selected frequency information item and the acquired handwriting;
providing the determined character type and the determined stroke order;
accepting determination results indicating whether the provided character type and the provided stroke order are correct; and
updating the frequency information items, if the determination results indicate that the provided character type and the provided stroke order are correct.

11. The method according to claim 8, wherein detecting the stroke order and the character type expressed by the acquired handwriting includes:
preparing a storage unit configured to store, as standard patterns, trace information items which corresponds to the character types and the stroke orders; and
comparing the acquired handwriting with each of the standard patterns, to compute a degree of similarity between a combination of the stroke order and the character type expressed by the acquired handwriting, and a combination of a corresponding character type and a corresponding stroke order included in each standard pattern.

12. The method according to claim 11, wherein determining the character type includes:
correcting the degree of similarity based on the selected frequency information item, and acquiring a corrected degree of similarity;
computing the corrected degree of similarity in units of combinations of character types and corresponding stroke orders included in the standard patterns; and
selecting, from the computed corrected degree of similarity in units of the combinations, a character type included in a combination which is a highest corrected degree of similarity.

13. A character recognition program stored in a computer readable medium, comprising:
means for instructing a computer to acquire handwriting written in a stroke order;
means for instructing the computer to access to a storage unit configured to store a plurality of character types, a plurality of stroke orders corresponding to each of the character types, and a plurality of frequency information items indicating frequencies with which the stroke orders are used; and
means for instructing the computer to determine a character type corresponding to the handwriting, based on one of the frequency information items which corresponds to the stroke order.

14. A character recognition program stored in a computer readable medium, comprising:
means for instructing a computer to acquire handwriting written in a stroke order;
means for instructing the computer to access to a storage unit configured to store a plurality of character types, a plurality of stroke orders corresponding to each of the character types, and a plurality of frequency information items indicating frequencies with which the stroke orders are used;
means for instructing the computer to detect the stroke order and a character type expressed by the acquired handwriting;
means for instructing the computer to select, from the storage unit, one frequency information item of the frequency information items which corresponds to the detected stroke order and the detected character type; and
means for instructing the computer to determine a character type corresponding to the acquired handwriting, based on the selected frequency information item and the acquired handwriting.

15. The program according to claim 14, further comprising:
means for instructing the computer to determine a stroke order corresponding to the acquired handwriting, based on the selected frequency information item and the acquired handwriting; and
means for instructing the computer to update the frequency information items based on the determined character type and the determined stroke order.

16. The program according to claim 14, further comprising:
means for instructing the computer to determine a stroke order corresponding to the acquired handwriting, based on the selected frequency information item and the acquired handwriting;
means for instructing the computer to provide the determined character type and the determined stroke order;
means for instructing the computer to accept determination results indicating whether the provided character type and the provided stroke order are correct; and
means for instructing the computer to update the frequency information items, if the determination results indicate that the provided character type and the provided stroke order are correct.

17. The program according to claim 14, wherein the detecting means includes:
means for instructing the computer to access to a storage unit configured to store, as standard patterns, trace information items which corresponds to the character types and the stroke orders; and
means for instructing the computer to compare the acquired handwriting with each of the standard patterns, to compute a degree of similarity between a combination of the stroke order and the character type expressed by the acquired handwriting, and a combination of a corresponding character type and a corresponding stroke order included in each standard pattern.

18. The program according to claim 17, wherein the determining means includes:
means for instructing the computer to correct the degree of similarity based on the selected frequency information item, and to acquire a corrected degree of similarity;
means for instructing the computer to compute the corrected degree of similarity in units of combinations of character types and corresponding stroke orders included in the standard patterns; and
means for instructing the computer to select, from the computed corrected degree of similarity in units of the combinations, a character type included in a combination which is a highest corrected degree of similarity.
